(19) United States
(12) Patent Application Publication
(10) Pub. No.: US 2013/0174938 A1
(43) Pub. Date: Jul. 11, 2013

(54) METHOD AND APPARATUS FOR ENHANCING THE DAMPING OF PNEUMATIC TIRES

(71) Applicant: Vladimir V. Vanstevich, Hoover, AL (US)

(72) Inventor: Vladimir V. Vanstevich, Hoover, AL (US)

(21) Appl. No.: 13/736,402

(22) Filed: Jan. 8, 2013

Related U.S. Application Data
(60) Provisional application No. 61/631,655, filed on Jan. 9, 2012.

(51) Int. Cl. B60C 23/04

(52) U.S. Cl. CPC B60C 23/0408
USPC 141/4; 141/83

(57) ABSTRACT

A method and apparatus for enhancing the damping of pneumatic tires employed on vehicles employing sensors disposed within the tire volume to detect road induced vibratory forces. A gas pump under control of the sensor through a servo-system either forces gas into the interior tire volume to enhance pressure increases induced by road forces or exhausts air from that chamber when the vibratory forces are reducing the pressure in the chamber. The air from the pump passes through capillary passages to create frictional losses which tend to damp vibratory forces on the tire.

### CROSS REFERENCE TO RELATED APPLICATIONS

This application claims priority of U.S. Provisional Application 61/631,655 filed Jan. 9, 2012, the contents of which are incorporated herein by reference.

### FIELD OF THE INVENTION

This invention relates to a method and apparatus for enhancing the damping of pneumatic tires employed on vehicles and more particularly to a system which senses pressure differentials occurring within a tire during operation of the vehicle as a result of road induced disturbances, and actively pumps gas into the tire in such a way as to increase the frictional losses and thus the vibration damping caused by the road disturbances.

### BACKGROUND OF THE INVENTION

Known passive systems for enhancement of damping of pneumatic tires of vehicles, without increasing rolling energy losses, teach dividing of the cavity by a partition into sub-cavities, A and B, as illustrated in FIG. 1 of the present application, so that when during the road-induced vibratory process the tire moves downward normally to the road surface, it deforms, and gas (air in most widely used pneumatic tires) pressure in sub-cavities A and B is changed differently, thus generating a pressure differential between these sub-cavities. The pressure differential results in flow of air between the sub-cavities A and B through a calibrated capillary C. Since this flow is a consequence of the vibration-induced pressure differential, loss of the flow energy due to friction within the capillary channel results in energy loss of the vibratory process, i.e. in damping enhancement of the tire system. When the tire moves upward, an oppositely directed pressure differential and flow would develop, again contributing to the loss of the vibratory energy (e.g., U.S. Pat. No. 5,891,278). Effectiveness of this system is limited since deformations of the tire caused by the vibratory process cause only very small volume changes and pressure differentials between the tire sub-cavities.

### SUMMARY OF THE INVENTION

The present invention is broadly directed toward an improvement in such passive systems for enhancement of tire damping. In a preferred embodiment of the invention, the system of the present invention employs a sensor to measure pressure variations in one of the two sub-cavities in the tire to measure vibration-induced pressure variations within that sub-cavity and a pump controlled by those measurements to feed gas into the sub-cavity being measured when the pressure variations indicate a road induced vibratory force is increasing the pressure in the sub-cavity, to further increase the pressure in that sub-cavity and thus intensify the flow through the capillary and the increased energy losses, i.e. damping of the tire. Similarly, when the sensor measurements indicates a road induced vibratory force is decreased the air pressure in the sub-cavity, to withdraw gas from that sub-cavity and thus cause flow through the capillary to again increase damping of the tire. In an alternative embodiment of the invention, the vibrational damping functional losses are generated in the pump itself, without the need for division of the tire volume into plural cavities.

### BRIEF DESCRIPTION OF THE DRAWINGS

Other objectives, advantages, and applications of the present invention will be made apparent by the following detailed description of preferred embodiments of the invention. The description makes reference to the accompanying drawings in which:

FIG. 1 is a cross-sectional view through a pneumatic tire employing a prior art passive system for enhancement of damping of a pneumatic vehicle tire;

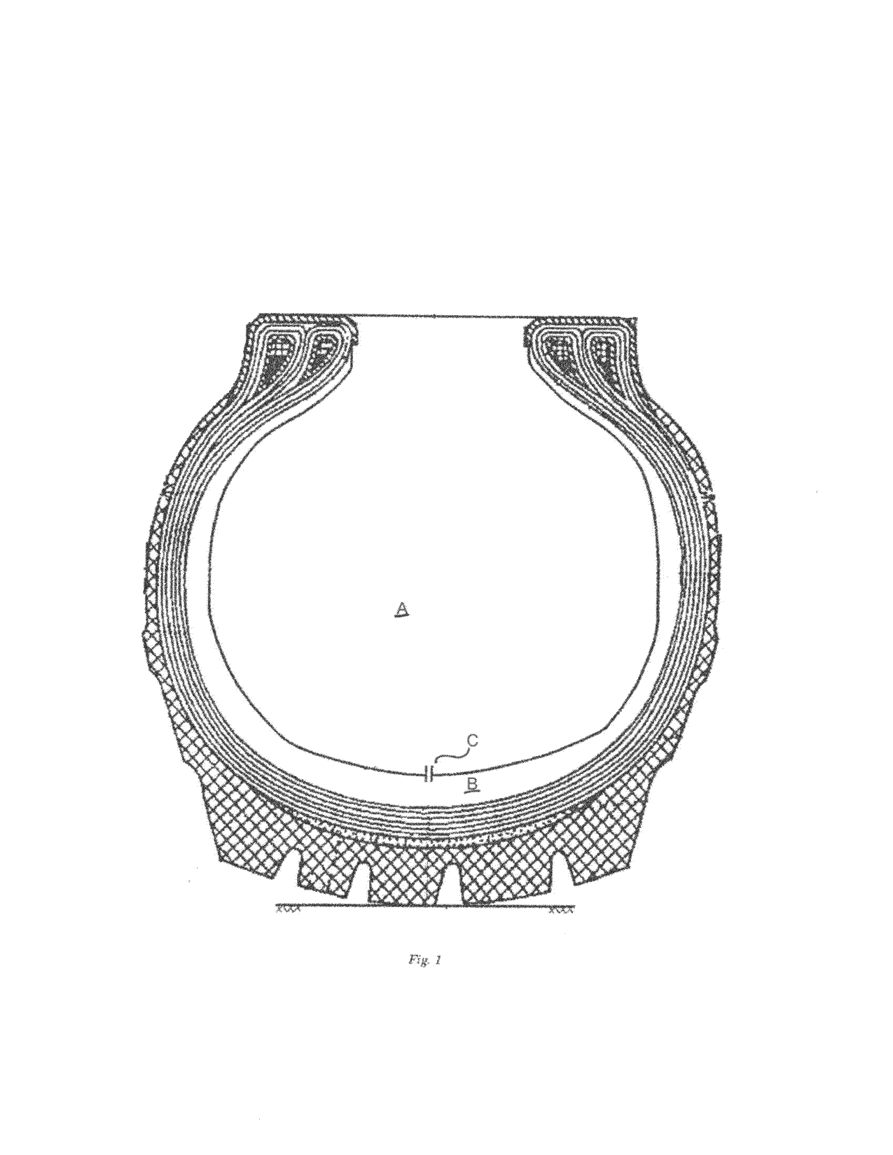

FIG. 2 is a semi-schematic cross-sectional view of a tire damping system formed in accordance with the present invention employing a pressure sensor in one of the cavities and a pump powered system for enhancing the pressure differentials occurring during operation of a vehicle employing the tire as a result of road-induced forces;

FIG. 3 is a semi-schematic cross-sectional view through an alternative embodiment of the present invention which does not employ a partition to divide the tire volume within separate chambers but generates frictional energy losses within the pressure differential enhancing pump itself; and

FIG. 4 is a semi-schematic cross-sectional view through another alternative embodiment of the invention in which the pressure increasing air flow is provided by a central tire inflation system.

### DETAILED DESCRIPTION OF THE PREFERRED EMBODIMENTS

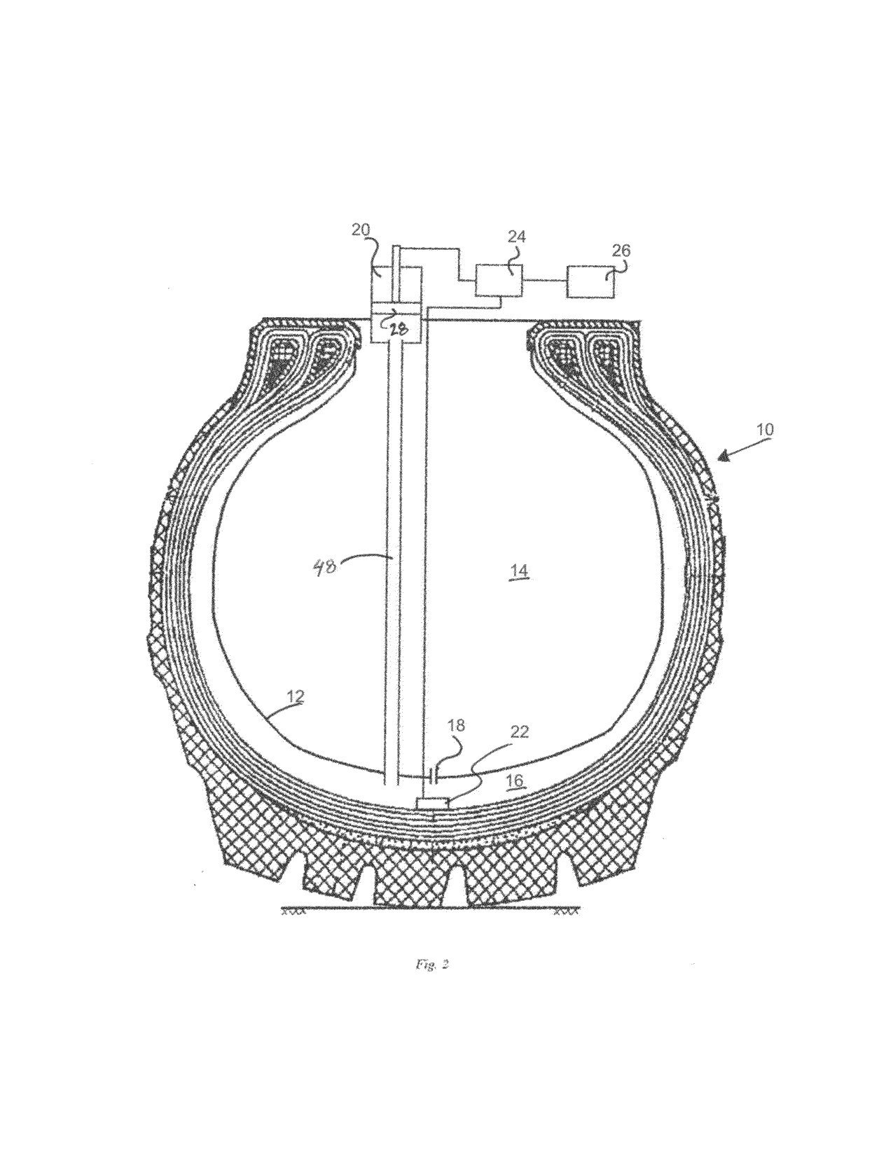

The preferred embodiment of the invention illustrated in FIG. 2, employed in an otherwise conventional pneumatic vehicle tire 10, incorporates a partition 12 dividing the interior tire volume into two sub-cavities, 14 and 16, which are connected by a capillary flow channel 18. The channel 18 may have a cross-dimension in the range of 0.2-1.75 mm and the preferred embodiment is 1 mm in cross-dimension; the optimal cross-dimension depends on the tire size, its elastic characteristics and inflation pressure. As set forth in U.S. Pat. No. 5,891,278, it is desirable in many applications to keep the resistance through the channel 18 constantly independent of the amplitude of vibration of the pressure changes in the tire interior volume as a result of road disturbances during driving. This can be achieved if the flow through the channel 18 remains laminar. This dictates that the Reynolds number (e) of the channel 18 does not exceed about Re=2,500. They Reynolds number for a given gas flow can be reduced by using several smaller channels instead of one, as may be done in alternative embodiments of the invention.

This embodiment differs from the prior art primarily in the provision of an air flow pump 20 controlled by a sensor 22 disposed within the sub-cavity 16 which measures vibration induced pressure variations in that chamber. The sensor 22 feeds back to the pump 20 through a servo-control system 24. The pump and the servo-control system are powered by an electrical source 26.

The pump 20 is shown schematically as a piston-cylinder pump, but it could take any other form of gas pump such as a centrifugal pump or the like.

In FIG. 2 the sensor is located in sub-cavity 16 although it could be connected with sub-cavity 14 instead. It is preferable that the sensor is connected within the sub-cavity experiencing greater vibration induced pressure variations. These pressure variations may be measured by a variety of detectors such as a pressure sensor, a tire deflection sensor, or any other sensor to monitor processes in the tire induced by the vibratory action of the external forces.

In the case of pressure measurement, pressure sensor 22 is disposed within the sub-cavity connected to the output of the feeder-pump through a conduit 48. When, during the vibratory process, air pressure is increasing in the sub-cavity 16 which is connected to the output of the feeder-pump 20, the servo-system 24 controls the feeder-pump 20 so that it moves to enhance the pressure in sub-cavity 16, increasing the pressure differential, and thus intensifying the flow through the capillary 18 and the energy losses, i.e. damping of the tire. When pressure in sub-cavity 16 is decreasing, the controlled motion of the piston 28 of the pump is in a direction to reduce the pressure in the sub-cavity 16, again enhancing the energy loss in the capillary flow and damping of the tire.

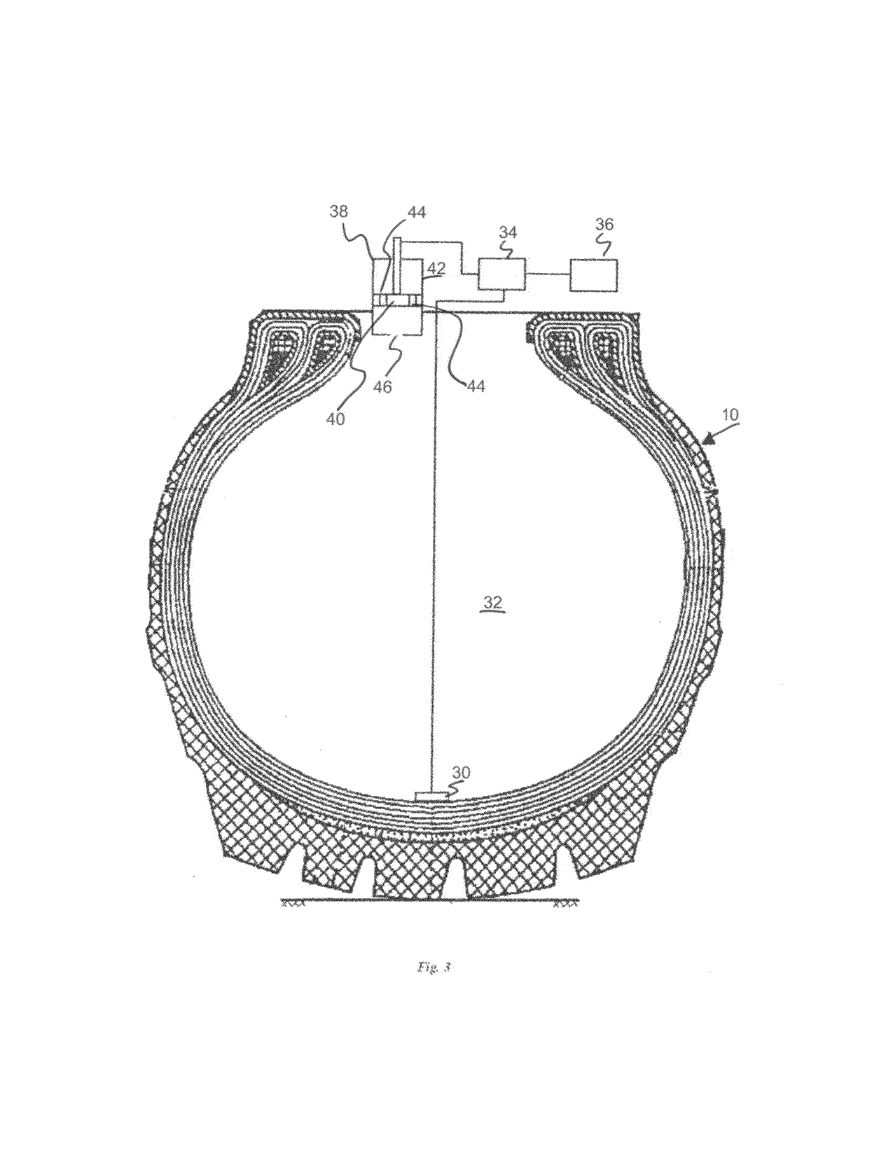

An alternative embodiment of the damping system of the present invention is illustrated in FIG. 3. In this embodiment the interior tire volume is not divided into sub-cavities. A sensor 30 like the one disclosed in connection with the embodiment of FIG. 2 is disposed within the single tire cavity. Again, the sensor 30 senses vibration induced pressure variations and feeds the signal through a servo-system 34 powered by an electrical supply 36.

The pump 38 employed in FIG. 3 is again a piston pump with the piston 40 moving within a cylinder 42. The piston has a plurality of capillary diameter flow channels 44 extending through its thickness, parallel to its direction of motion, so that air forced through the piston 40 as it moves upwardly or downwardly is forced through these channels 44 thus, when the pressure in the tire is increasing the motion of the piston 40 is downwardly as illustrated in FIG. 3, forcing gas into the interior tire volume through an inflow channel 46 formed in the bottom of the cylinder. Under control of the servo-system 34 the piston 40 moves in such a direction as to increase the pressure in the interior tire volume when that pressure is otherwise increasing as a result of road induced vibrations in the tire and the piston moves upwardly as viewed in FIG. 3 when the sensor 30 determines that the pressure within in the tire is decreasing to similarly generate energy losses which increase the damping of the tire.

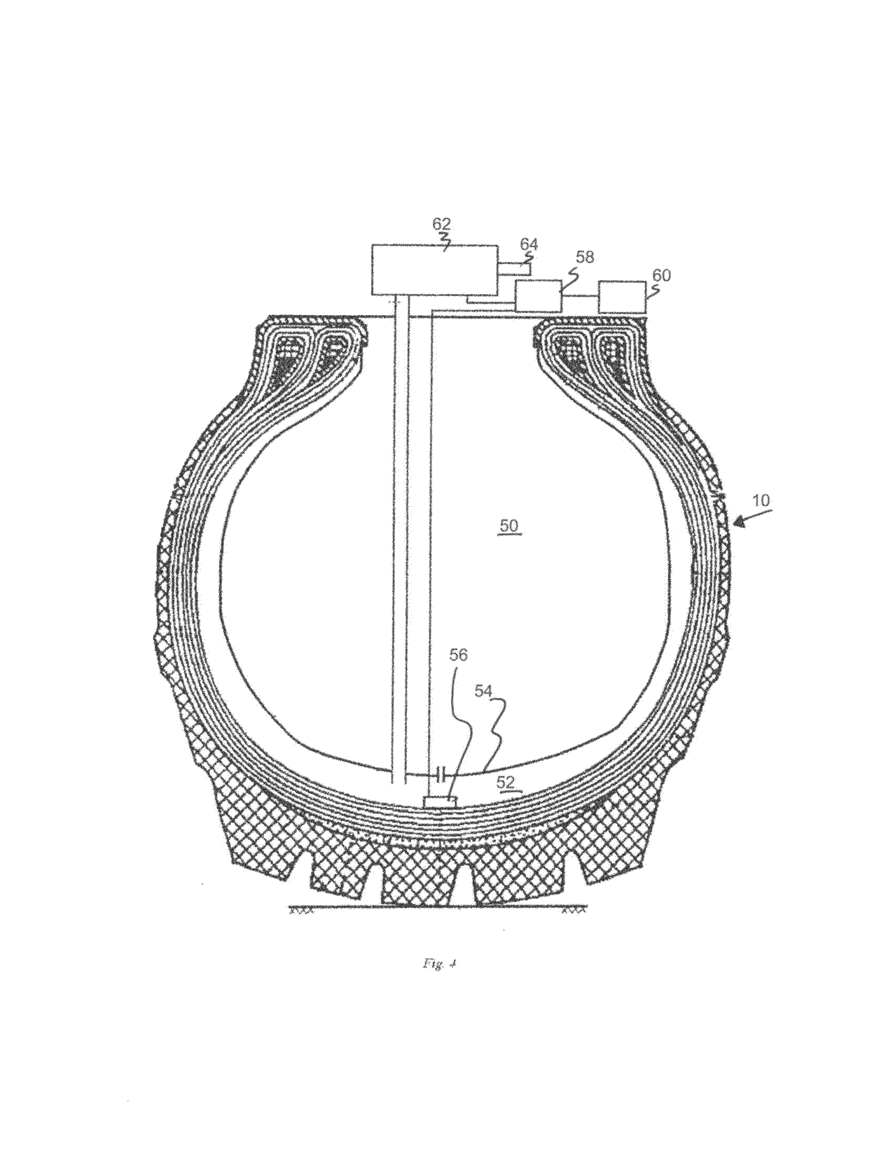

FIG. 4 illustrates another alternative embodiment of the invention wherein the interior of the tire 10 is again divided into two sub-cavities 50 and 52 by a partition 54. A sensor 56 is again disposed in the volume closest to the tire exterior so as to be more sensitive to pressure changes induced by road forces. The sensor has its electrical output connected to a servo-system 58, which is powered by an electrical source 60, to control a valve 62 which it has input from the output line 64 of a central tire inflation system for the tires of the vehicle (not shown). The valve 62 emits a gas from the central inflation system into the chamber 52 when the sensor 56 detects an increase in pressure in that chamber, and exhausts a gas from the chamber 52 when the pressure in the chamber is decreasing due to road forces.

This control of the wheel valve assembly does not conflict with the main control of the central tire inflation system since the driver may be provided with a switch to allow the tire inflation system to operate in its normal mode or in the tire damping mode.

Having thus described my invention, I claim:

1. Apparatus for enhancing the damping of a pneumatic tire on a vehicle having a gas inflated interior volume, comprising:
a sensor disposed in said interior volume for generating a signal based on gas pressure variations within said interior volume occurring during operation of the vehicle as a result of road-induced forces;
a capillary flow channel; and
a gas pump controlled by said signal operative to pump gas through said capillary flow channel and into said interior volume to enhance the pressure differentials occurring during the operation of the vehicle and thereby increasing the damping of the vibration forces resulting from frictional losses through said capillary channel.

2. The apparatus for enhancing the damping of pneumatic tires of claim 1, wherein the interior volume of the tire is divided into two sub-cavities by a partition and the sensor is located in the sub-cavity experiencing the greatest vibration induced pressure variations.

3. The apparatus for enhancing the damping of pneumatic tires of claim 2, wherein said capillary channel is formed through said partition.

4. The apparatus for enhancing the damping of tires of claim 1, wherein the pump is a piston pump moving within a cylinder and the capillary channels are formed through the thickness of the piston.

5. The apparatus for enhancing the damping of tires of claim 1, wherein the output of the sensor is connected to a driver for the pump through a servo-system.

6. A method of enhancing the damping of a pneumatic tire of a vehicle having a gas inflated interior volume, comprising:
sensing gas pressure variations in said interior volume to generate a signal based on gas pressure variations within said interior volume occurring during operation of the vehicle as a result of road-induced forces to generate a signal based on the variations; and
pumping gas under control of said signal through a capillary flow channel and into said interior volume to enhance the pressure differentials occurring during the operation of the vehicle and thereby increasing the damping of the vibration forces resulting from frictional losses through said capillary channel.
